(19) United States
(12) Patent Application Publication
(10) Pub. No.: US 2025/0026941 A1
(43) Pub. Date: Jan. 23, 2025

(54) COATING COMPOSITION WITH CERIUM(III) CARBONATE AND A PHOTOINITIATOR

(71) Applicant: Rohm and Haas Company, Collegeville, PA (US)

(72) Inventors: Keith A. Alderfer, Telford, PA (US); Timothy P. Moneypenny, Pottstown, PA (US); James C. Bohling, Lansdale, PA (US); Juan F. Callejas, Audubon, PA (US); Stephanie M. Bortko, Perkiomenville, PA (US); David J. Bluder, Quakertown, PA (US)

(21) Appl. No.: 18/713,449

(22) PCT Filed: Dec. 6, 2022
(86) PCT No.: PCT/US2022/051909

§ 371 Date: May 24, 2024

Related U.S. Application Data
(60) Provisional application No. 63/290,686, filed on Dec. 17, 2021.

(51) Int. Cl. C09D 7/61; C08K 3/22; C08K 3/26; C08K 5/101; C09D 7/63

(52) U.S. Cl. CPC C09D 7/61; C08K 3/22; C08K 3/26; C08K 5/101; C09D 7/63; C08K 2003/2241

(57) ABSTRACT

The present invention relates to a composition comprising cerium (III) carbonate and a photoinitiator. The composition is useful for paints formulations that benefit from dirt pickup resistance and retention of color over time.

### BACKGROUND OF THE INVENTION

The present invention relates to a coating composition, more particularly a paint composition comprising cerium (III) carbonate and a photoinitiator. The composition of the present invention provides improved dirt pickup resistance and tint retention.

Dirt pick-up resistance (DPUR) of a coating designed for exterior applications can be improved with the addition of photoinitiators such as benzophenone and derivatives thereof.

Photoinitiators initiate controlled crosslinking by forming a UV-initiated radical that reacts with a polymer film at the film surface. Unfortunately, the improvement in DPUR arising from the presence of a photoinitiator additive is offset over time with increased chalking and color fade of the coating. It would therefore be an advance in the art of exterior paints to find a way to improve DPUR without substantial color fade or chalking.

### SUMMARY OF THE INVENTION

The present invention addresses a need in the art by providing a composition comprising a mixture of water, a photoinitiator, and cerium (III) carbonate. The composition of the present invention is useful in paint formulations, especially exterior paint formulations, where dirt pickup resistance and color retention are desired.

### DETAILED DESCRIPTION OF THE INVENTION

The present invention is a composition comprising a mixture of water, a photoinitiator, and cerium (III) carbonate particles. In another aspect, the present invention is a mixture of water, latex binder particles, opacifying pigment particles, a rheology modifier, a photoinitiator, and cerium (III) carbonate particles.

The latex binder particles are film-forming at room temperature, either alone or in the presence of a coalescent. Examples of latex binder particles include, for example, acrylic, styrene-acrylic, styrene-butadiene, urethane, ester, olefin, vinyl chloride, ethylene vinyl acetate, epoxy, and polyvinyl acetate-based latex binder particles, with acrylic and styrene-acrylic latex binder particles being preferred. The latex binder particles preferably have a z-average particle size as measured by dynamic light scattering in the range of from 80 nm, or from 100 nm to 500 nm, or to 350 nm.

Opacifying pigment particles have an index of refraction of at least 1.8 or at least 2.0 and preferably an average particle diameter in the range of from 150 nm or from 200 nm, to 500 nm or to 350 nm. The average particle diameters of pigment particles are typically provided by pigment particle suppliers. Examples of suitable opacifying pigments include TiO₂ and ZnO, with TiO₂ being preferred.

Photoinitiators, as used herein, are aromatic organic compounds that produce radicals when exposed to UV light. One particular class of photoinitiators contains a carbonyl group alpha to an aromatic ring:

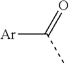

where Ar is a substituted or unsubstituted monocyclic aromatic group such as phenyl or phenyl substituted with C₁-C₆-alkyl, C₁-C₆-alkoxy, C₁-C₆-alkylthio, carbo-C₁-C₁₀-alkoxy, halo, or phenyl groups, or combinations thereof; or a polycyclic aromatic group such as naphthyl, thioxanthonyl, fluorenyl, anthryl, or phenanthryl groups.

Examples of photoinitiators include diphenyl ketones such as benzophenone and methyl-2-benzoylbenzoate; 1-benzoylcycloalkanols such as 1-benzoylcyclohexanol; mono- and diacyl phosphines such as (2,4,6 trimethylbenzoyl)diphenylphosphine oxide and bis(2,4,6-trimethylbenzoyl)phenylphosphine oxide; α-hydroxyphenones such as 2-hydroxy-2-methyl-1-phenyl-1-propanone; C₁-C₆-alkyl thioxanthones such as isopropyl thioxanthone; C₁-C₁₀-alkyl dimethylaminobenzoates including 2-ethylhexyl-(4-N,N-dimethylamino)benzoate; C₁-C₆-alkyl benzoylformates including methylbenzoylformate and ethylbenzoylformate; and 2,2-di-C₁-C₆-alkyl- and di-C₁-C₆-alkoxyethan-1-ones including 2,2-dimethoxy-1,2-diphenylethan-1-one.

The photoinitiator may also be chemically incorporated into the latex particles. For example, a photoinitiator with olefinic unsaturation may be copolymerized with monomers to form photoinitiator functionalized latex binder particles. Thus, in another aspect, the composition comprises a mixture of water, a photoinitiator, opacifying pigment particles, a rheology modifier, and cerium (III) carbonate particles, where the photoinitiator is in the form of latex binder particles functionalized with photoinitiator groups. As used herein “photoinitiator groups” are groups that produce radicals when exposed to UV light. The photoinitiator can be chemically incorporated into the latex binder particles by emulsion copolymerization of an ethylenically unsaturated photoinitiator and other monomers such as acrylates and methacrylates. An example of a photoinitiator monomer is

2-hydroxy-3-(methacryloyloxy) propyl 2-benzoylbenzoate:

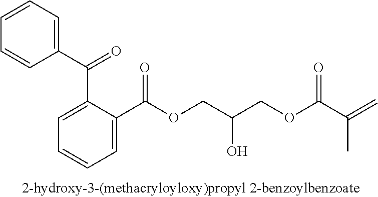 [SMILES: C=C(C)C(=O)OCC(O)COC(=O)c1ccccc1C(=O)c1ccccc1]

The concentration of photoinitiator in the composition is typically in the range of from 0.05 or from 0.1 or from 0.2 to 5 or to 3 or to 1 weight percent, based on the weight of the composition. If the photoinitiator is in the form of latex binder particles functionalized with photoinitiator groups, the concentration refers to the concentration by weight of pendant photoinitiator groups, based on the weight of the composition.

The concentration of cerium carbonate in the composition is generally in the range of from 0.2 or from 0.5 or from 1 weight percent, to 20 or to 10 weight percent, based on the weight of the opacifying pigment, preferably TiO₂. Cerium (III) carbonate can be prepared by methods known in the art, for example, US2020/0339435 A1, beginning at para [0100].

The composition is preferably a paint composition suitable for exterior coating applications. As such, the composition preferably further includes one or more additional materials selected from the group consisting of surfactants, dispersants, coalescents, defoamers, biocides, extenders, colorants, and neutralizers. Coatings prepared from the composition of the present invention show remarkably good DPUR, despite the presence of cerium carbonate, which was previously believed likely to degrade DPUR.

### EXAMPLES

### Intermediate Example 1—Preparation of Cerium Carbonate Paste

An aqueous solution of cerium (III) ammonium nitrate tetrahydrate (200 g (NH₄)₂Ce(NO₃)_{5·4}H₂O in 2000 g DI water) was added rapidly and with agitation to an aqueous of solution of ammonium carbonate ((100 g (NH₄)₂CO₃) in 500 g DI water). The reaction mixture was stirred at room temperature for 10 min, then collected via filtration and washed three times with DI H₂O to afford a white slurry with a solids content of 18.7%.

Table 1 illustrates the paint formulations tested for dirt pick-up resistance. All numbers are relative weights and reported as parts by weight (pbw). Preservative 1 refers to Kathon LX 1.5% Preservative; Preservative 2 refers to Bioban 200 Preservative; Dispersant refers to TAMOL™ 165A Dispersant; Surfactant refers to TRITON™ HW-1000 Surfactant; Silicone Additive refer to DOWSIL™ 8590 Additive; TiO₂ refers to Ti-Pure R-706 TiO₂; Extender refers to Minex Nepheline Syenite; cerium carbonate refers to 18.7 aq. wt. % cerium (III) carbonate paste; Surfactant 2 refers to TERGITOL™ 15-S-12 Surfactant; Ammonia refers to 28 aq. wt. % ammonia; Latex refers to a 50% solids by wt. aqueous dispersion of butyl acrylate, methyl methacrylate, methacrylic acid, ureido methacrylate based latex having a T_{g} of 2° C., as calculated by the Fox equation, a z-average particle size of 135 nm by dynamic light scattering; with a latex pH of 8; Coalescent refers to Optifilm Enhancer 400 Coalescent; RM1 refers to ACRYSOL™ RM-3030 Rheology Modifier; RM2 refers to ACRYSOL RM-995 Rheology Modifier; and Photointiator refers to methyl-2-benzoylbenzoate (M2BB) 50% by wt. in acetone. (TAMOL, TRITON, DOWSIL, TERGITOL, and ACRYSOL are all Trademarks of The Dow Chemical Company or its Affiliates.)

TABLE 1
Paint Formulations

| | Comp. Ex 1 | Comp. Ex. 2 | Comp. Ex. 3 | Example |
|---|---|---|---|---|
| Grind (pbw) | | | | |
| Water | 60.8 | 60.8 | 60.8 | 60.8 |
| Preservative 1 | 1.8 | 1.8 | 1.8 | 1.8 |
| Preservative 2 | 6.0 | 6.0 | 6.0 | 6.0 |
| Dispersant | 8.4 | 8.4 | 8.4 | 8.4 |
| Surfactant 1 | 2.0 | 2.0 | 2.0 | 2.0 |
| Silicone Additive | 1.0 | 1.0 | 1.0 | 1.0 |
| TiO₂ | 250.0 | 250.0 | 250.0 | 250.0 |
| Extender | 50.0 | 50.0 | 50.0 | 50.0 |
| Grind Total | 380 | 380 | 380 | 380 |
| Grind Post-Ad | | | | |
| Cerium | 0.0 | 0.0 | 53.5 | 53.5 |
| Carbonate^{a} | | | | |
| Letdown (pbw) | | | | |
| Water | 104.2 | 104.2 | 104.2 | 104.2 |
| Surfactant 2 | 2.0 | 2.0 | 2.0 | 2.0 |
| Latex | 463.5 | 463.5 | 463.5 | 463.5 |
| Ammonia | 1.0 | 1.0 | 1.0 | 1.0 |
| Silicone Additive | 0.5 | 0.5 | 0.5 | 0.5 |
| Propylene Glycol | 2.2 | 2.2 | 2.2 | 2.2 |
| Coalescent | | | | |
| RM1 | 10.4 | 10.4 | 10.3 | 10.3 |
| RM2 | 5.7 | 5.8 | 5.7 | 5.5 |
| Water | 97.4 | 96.9 | 52.0 | 50.2 |
| Photoinitiator | 0.0 | 3.8 | 0.0 | 3.8 |

^{a}Cerium carbonate was added to the grind and blended using a FlackTek mixer.

### Accelerated Lab DPUR Method:

An accelerated lab method for testing dirt pick up resistance (DPUR) was carried out using a drawdown of the tested coating on a 7.5-×15-cm aluminium panel (˜5 mil) followed by a 1-day cure time, a 3-day QUV conditioning, an application of an aqueous brown iron oxide slurry, and a cleaning of the soiled panels. The soiled panels were cleaned with gentle agitation with tepid tap water; reflectance measurements were used to determine the tendency of the coating to retain the dirt. L* reflectance (45/0) measurements were taken on panels before being soiled and after cleaning of dirt slurry application. Delta L* (final L*-initial L*) values were calculated from the reflectance readings. More negative ΔL* values indicate higher collection of dirt, that is, poorer dirt pick-up resistance. The photoinitiator was M2BB. Cerium carbonate percentages were based on the w/w solids % of TiO₂. Table 2 shows the ΔL* values after QUV conditioning.

TABLE 2
ΔL* values after QUV conditioning

| | Comp. Ex. 1 | Comp. Ex. 2 | Comp. Ex. 3 | Ex. 1 |
|---|---|---|---|---|
| Photoinitiator % | 0 | 0.8 | 0.8 | 0 |
| Cerium | 0 | 0 | 4.0 | 4.0 |
| Carbonate % | | | | |
| ΔL* | −10.5 | −0.2 | −7.2 | −0.4 |

Surprisingly, the data show that the inclusion of cerium (III) carbonate in a paint containing a photoinitiator did not adversely impact the dirt pick-up resistance as compared with the sample with photoinitiator only. Inasmuch as cerium (III) carbonate was shown in a separate experiment to retain tint strength, the combination of photoinitiator and cerium (III) carbonate give the elusive combination of improved dirt pickup resistance and tint strength retention.

1. A composition comprising a mixture of water, a photoinitiator, and cerium (III) carbonate particles.

2. The composition of claim 1 which further comprises latex binder particles, opacifying pigment particles, and a rheology modifier.

3. The composition of claim 2 wherein the latex binder particles are acrylic, styrene-acrylic, styrene-butadiene, urethane, ester, olefin, vinyl chloride, ethylene vinyl acetate, epoxy, or polyvinyl acetate-based latex binder particles.

4. The composition of claim 2 wherein the opacifying pigment is TiO₂.

5. The composition of claim 1 wherein the photoinitiator is selected from the group consisting of diphenyl ketones, 1-benzoylcycloalkanols; monoacyl phosphines, diacyl phosphines; α-hydroxyphenones; C₁-C₆-alkyl thioxanthones; C₁-C₁₀-alkyl dimethylaminobenzoates; 2,2-di-C₁-C₆-alkylethan-1-ones, and di-C₁-C₆-alkoxyethan-1-ones.

6. The composition of claim 4 wherein the photoinitiator is selected from the group consisting of benzophenone; methyl-2-benzoylbenzoate; (2,4,6 trimethylbenzoyl)diphenylphosphine oxide; bis(2,4,6-trimethylbenzoyl)phenylphosphine oxide; 2-hydroxy-2-methyl-1-phenyl-1-propanone; isopropyl thioxanthone; 2-ethylhexyl-(4-N,N-dimethylamino)benzoate; methylbenzoylformate; ethylbenzoylformate; and 2,2-dimethoxy-1,2-diphenylethan-1-one, and the latex binder particles are acrylic or styrene-acrylic binder particles.

7. The composition of claim 4 wherein the concentration of the photoinitiator is in the range of 0.1 to 5 weight percent, based on the weight of the composition.

8. The composition of claim 7 wherein the concentration of cerium (III) carbonate is in the range of from 0.2 to 20 weight percent, based on the weight of the TiO₂ particles.

9. The composition of claim 6 wherein the concentration of cerium (III) carbonate is in the range of from 0.5 to 10 weight percent, based on the weight of TiO₂ particles, and the concentration of the photoinitiator is in the range of from 0.1 to 1 weight percent, based on the weight of the composition; and wherein the latex binder particles are acrylic or styrene-acrylic binder particles.

10. The composition of claim 9 wherein the photoinitiator is benzophenone or methyl-2-benzoylbenzoate.

11. The composition of claim 2 which further comprises one or more materials selected from the group consisting of surfactants, dispersants, coalescents, defoamers, biocides, extenders, colorants, and neutralizers, wherein the composition is an exterior paint.

12. The composition of claim 1 which further comprises an opacifying pigment and a rheology modifier, wherein the photoinitiator is in the form of latex binder particles functionalized with photoinitiator groups.
